(19) United States
(12) Patent Application Publication
(10) Pub. No.: US 2026/0079867 A1
(43) Pub. Date: Mar. 19, 2026

(54) ITERATIVE DIRECT MEMORY ACCESS FOR CACHE-FRIENDLY WRITE OUT

(71) Applicants: ADVANCED MICRO DEVICES, INC., Santa Clara, CA (US); ATI TECHNOLOGIES ULC, MARKHAM (CA)

(72) Inventors: Raman R. Jana, Austin, TX (US); Ramkumar Jayaseelan, Houston, TX (US); Ian Richard Beaumont, Lindfield (AU); Ahmed Mohammed ElShafiey Mohammed ElTantawy, Woodbridge (CA); Thomas Plano, Lowell, MA (US)

(21) Appl. No.: 18/887,784

(22) Filed: Sep. 17, 2024

(51) Int. Cl. G06F 13/28

(52) U.S. Cl. CPC G06F 13/28; G06F 2213/28

(57) ABSTRACT

A DMA controller iteratively loads regions of tensor data from global memory to a shared memory of a processor to generate an output from matrix multiplication in a format in which rows of data are contiguous in memory. In a first iteration, the DMA controller loads a first region of data that includes a plurality of rows, each row separated by a tile stride from the preceding row, from the tile to a first contiguous region of the shared memory. In a second iteration, the DMA controller loads a second region of data that includes a plurality of rows, each row separated by a tile stride from the preceding row, from the tile to a second contiguous region of the shared memory. The second region of data is offset from the first region of data in global memory by a configurable offset.

### BACKGROUND

Techniques described herein generally relate to parallel computing, and more specifically to the field of large-scale machine learning model training across multiple processing units, such as parallel coprocessors, accelerated processors (APUs), central processing units (CPUs), graphical processing units (GPUs), vector processors, tensor processors, neural processors, and the like. Large-scale machine learning (ML) techniques have been popularly applied to a wide range of applications, including image and speech recognition, natural language processing, and many others. The training of ML models, especially large-scale models, requires significant computational resources. To handle these computational demands, some processing systems utilize multiple parallel processors to perform parallel computing, which can significantly reduce the time required for model training.

The model's weights, optimizer states, and gradients may be stored at a global memory that is shared across a set of multiple parallel processors participating in the training. This approach enables the model to exceed the memory constraints of a single parallel processor and makes it possible to train larger models. However, storing the data at the global memory necessitates performing various resource-intensive memory operations prior to execution of the matrix-to-matrix multiplication operations (e.g., General Matrix to Matrix Multiplication or GEMM operations) for every layer of the model, posing efficiency challenges for large-scale model training. Therefore, some processing systems employ one or more direct memory access (DMA) controllers to asynchronously load and store data from the global memory to a shared memory of a parallel processor and vice versa.

A DMA controller is a hardware device which coordinates direct memory access transfers of data between devices (e.g., input/output interfaces and display controllers) and memory, or between different locations in memory, within a computer system. A DMA controller is often located on a processor, such as a central processing unit (CPU) or an accelerated processing unit such as a parallel processor and receives commands from an application running on the processor. Based on the commands, the DMA controller reads data from a DMA source (e.g., global memory) and writes data to a DMA destination (e.g., a shared memory).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to task a direct memory access (DMA) controller with iteratively loading data to a shared memory of a processor for cache-friendly write out following matrix multiplication using the data in accordance with some embodiments.

FIG. 2 is a diagram illustrating normal operation of a DMA controller tasked with loading data to a shared memory of a processor for matrix multiplication.

FIG. 3 is a diagram illustrating iterative loading of data by a DMA controller for cache-friendly write out following matrix multiplication using the data in accordance with some embodiments.

FIG. 4 is a diagram illustrating iterative loading by a DMA controller from global memory to a shared memory in accordance with some embodiments.

FIG. 5 is a diagram illustrating a driver sending a load instruction and a descriptor including parameters for iterative direct memory access to a DMA controller in accordance with some embodiments.

FIG. 6 is a diagram illustrating interleaving of matrix elements at a compute unit register for processing of multiple elements in a single thread in accordance with some embodiments.

FIG. 7 is a diagram illustrating insertion of padding at varying increments during iterative loading of data by a DMA controller in accordance with some embodiments.

FIG. 8 is a flow diagram illustrating a method for iteratively loading tensor tile data by a DMA controller in accordance with some embodiments.

### DETAILED DESCRIPTION

Applications (e.g., shader programs, raytracing programs) executing on a processing system generate program code indicating a plurality of work items (e.g., functions, operations) to be performed for the application. In some embodiments, the processing system is configured to group such work items into one or more workgroups each including a respective number of waves (e.g., sub-groups of work items) to be performed. To execute these waves for a workgroup, the processing system includes a parallel processor that has one or more shader engines (also referred to herein as shaders) that in turn each include one or more compute units.

The parallel processor may include one or more DMA controllers (also referred to as DMA engines) to read and write blocks of data stored in a system memory. The DMA controllers relieve shaders from the burden of managing transfers. In response to data transfer requests from the shaders, the DMA controllers provide requisite control information to the corresponding source and destination such that data transfer operations can be executed without delaying computation code, thus allowing communication and computation to overlap in time. With the DMA controllers asynchronously handling the formation and communication of control information, the shaders are freed to perform other tasks while awaiting satisfaction of the data transfer requests. Typically, a DMA controller copies data from one location to another by performing load/store operations in which the DMA controller loads the data from system memory (e.g., dynamic random-access memory (DRAM)) over, e.g., a Peripheral Component Interconnect Express (PCIe) bus, and stores the data at another memory component such as a static random-access memory (SRAM) that is shared to a shader. For example, a DMA controller manually requests data to be loaded into a scratchpad memory from system memory via a memory hierarchy (which may contain one or more caches at different levels within the memory hierarchy). Each level of the memory hierarchy may include a cache which may be populated (e.g., with specific cache directives from the requester) as data is loaded from a lower level and returned to a requester.

For applications such as machine learning, some of the data structures that are processed in waves executed by shaders of a parallel processor are tensors, which are multi-dimensional arrays of numbers that represent complex data. A shader may task a DMA controller with tensor load/store operations such as copying tensor data from global memory to shared memory and vice versa. Each tensor load/store operation is indicated by a descriptor, which specifies the tensor's location in memory as well as characteristics of the tensor such as the tensor width and stride and whether the tensor is to be copied from global memory to shared memory or from shared memory to global memory. Based on each descriptor, the DMA controller generates multiple (e.g., hundreds or thousands) of memory copy requests.

For tensor multiplication operations that are common in machine learning applications, a DMA controller transfers a matrix referred to as a tile from a tensor stored in global memory to a shared memory that is local to a processor such as a matrix tensor core. The processor reads the tile of data, performs a matrix multiplication operation, and accumulates the result in an accumulator register. The result is then moved from the accumulator register to the shared memory, from which the result is written out to the global memory.

Matrix multiplication performance depends on several factors: the performance of loading the data from the global memory, the performance of the matrix multiplication operations themselves, and the performance of storing (i.e., writing out) the result to the global memory. The use of a DMA controller to asynchronously load the data from the global memory to the shared memory removes the loading time from the performance equation. For operations that require the multiplication of a large vector space (i.e., vectors having higher k dimensions in a [m, k]×[k, n] operation), the multiplication operation is the dominant factor in the performance equation, as the number of multiplies and adds for each element is large. However, when smaller k dimensions are used, the time to calculate each element is reduced and the cost of writing out the result can become a limiting performance factor.

If the results of the matrix multiplication are not in cacheline-sized chunks, the write out performance is poor. For example, a processor typically accumulates an output of matrix multiplication in a 16×2 (row×column) to a register in a format in which each column is strided in memory and effectively lies in a different cacheline. Thus, two halves of separate cachelines are used for each write to global memory from the accumulator register (and/or shared memory) of the processor, resulting in poor performance when writing out the data.

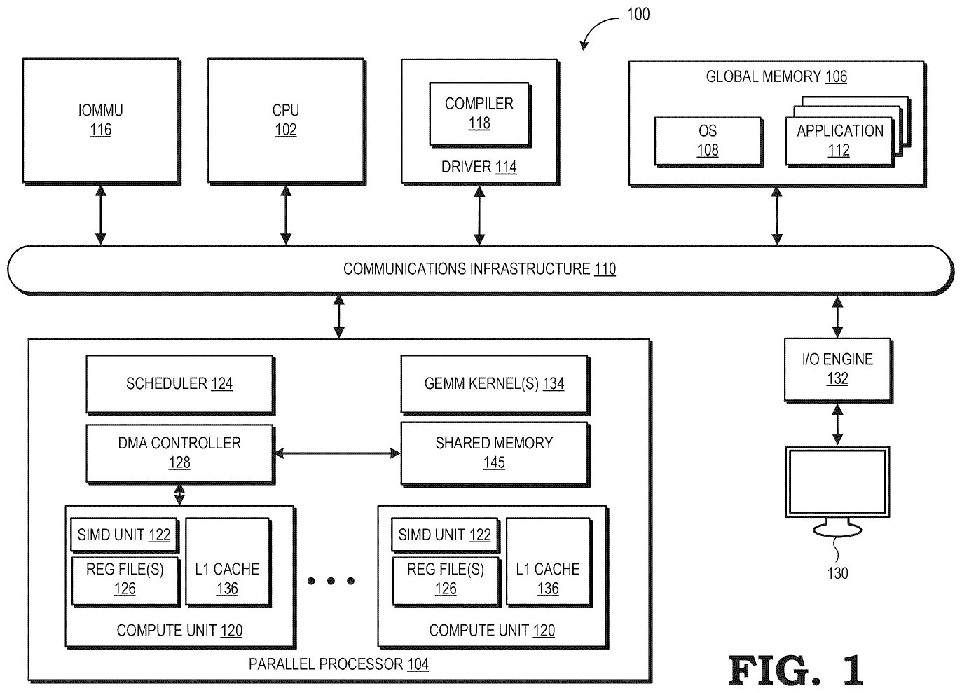

FIGS. 1-8 illustrate techniques for iteratively loading portions of tensor data from global memory to a shared memory of a processor to generate an output from matrix multiplication in a format in which rows of data are contiguous in memory. When each cacheline includes a row of contiguous data, the DMA controller can store the results from the accumulator register or shared memory of the processor to the global memory in full cacheline-size chunks, resulting in more efficient transfers of result data from shared memory to global memory than conventional transfers which must be performed in half-cacheline increments.

Iteratively loading the portions of tensor data involves moving portions of data from a first region in global memory to a second region in shared memory, where rows of the first region that are offset by a tile stride are stored in contiguous rows of the second region. For example, in a first iteration, the DMA controller loads a first portion of data that includes a plurality of rows, each row separated by a tile stride from the preceding row, from the tile to a first contiguous region of the shared memory. In a second iteration, the DMA controller loads a second portion of data that includes a plurality of rows, each row separated by a tile stride from the preceding row, from the tile to a second contiguous region of the shared memory. The second portion of data is offset from the first portion of data in global memory by a configurable offset.

The rearrangement of the strided rows of data from the tile in global memory to contiguous rows of data in shared memory enables the processor to generate an output following a matrix multiplication operation using the first portion of data and the second portion of data that is contiguous within cachelines for writing out to global memory. The first portion of data starts at a base address and the second portion of data starts at the base address plus a configurable offset. The DMA controller loads the first portion of data to a base destination address in the processor shared memory and loads the second portion of data to the base destination address plus a configurable offset at the processor shared memory. In some implementations, the DMA controller adds padding to at least one of the first portion of data and the second portion of data at the shared memory.

The DMA controller performs the iterative loading in response to a load instruction and a descriptor indicating parameters for a load request such as the base address of the tile in global memory, the tile dimensions, the region dimensions, the tile stride, and an iteration count (i.e., number of times to iteratively load portions of data from the tile). In response to receiving the load instruction and the descriptor, the DMA controller iteratively loads successive portions of data from the tile of tensor data until the specified number of iterations has been performed. For example, if more than two iterations are specified in the descriptor, the DMA controller performs a third iteration following the second iteration by loading a third portion of data from the tile. The third portion of data is offset from the second portion of data in global memory by the specified stride and, when used in a matrix multiplication operation by the processor using the second portion of data and the third portion of data, the processor generates an output at the accumulator register of the processor that is contiguous within cachelines in global memory.

In some implementations, the DMA controller interleaves the elements of the tensor data for threads executing at the compute units of the processor. Interleaving the elements of the tensor data enables the compute units to pack multiple elements into a single thread and write out the multiple elements while avoiding bank conflicts. The number of elements that are written out in a single thread corresponds to a stride of the interleaving. For example, if the interleaving stride is two, such that every other element is interleaved at the register of a compute unit, the compute unit writes out two elements per thread, thus reducing the number of writes per thread by half. In some implementations, the interleave stride is, e.g., four or eight, and the compute unit writes out four or eight elements per thread.

By performing DMA loads of tensor tile data in multiple iterations, the DMA controller also has more flexibility to insert padding into the tensor data. Whereas data precisions such as f8, f16, and f32 scale data precisions in byte-sized increments, other formats such as f6 do not align with byte boundaries. In some implementations, the stride for iterative loading specified by a descriptor aligns with f6 data precision boundaries and inserts padding to align the fetched data with byte boundaries. For example, if the stride is six bits, the DMA controller may be instructed by the descriptor to insert two bits of padding at each iteration. Other padding patterns for f6 precision data include, e.g., inserting 4 bytes of padding for every 12 bytes of data to enable 96 bytes of data to be aligned with 128 bytes. Inserting padding at specified increments while iteratively loading tensor data also facilitates avoiding bank conflicts when the tensor data is being read.

The techniques described herein are, in different embodiments, employed at any of a variety of parallel processors (e.g., accelerated processing units (APUs), matrix tensor cores, vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of a processing system 100 including a parallel processor 104, in accordance with some embodiments. In at least some embodiments, the processing system 100 is a computer, laptop/notebook, mobile device, gaming device, wearable computing device, server, or any of various other types of computing systems or devices. It is noted that the number of components of the processing system 100 varies from embodiment to embodiment. In at least some embodiments, there is more or fewer of each component/subcomponent than the number shown in FIG. 1. It is also noted that the processing system 100, in at least some embodiments, includes other components not shown in FIG. 1. Additionally, in other embodiments, the processing system 100 is structured in other ways than shown in FIG. 1.

The parallel processor 104, in some embodiments, renders images for presentation on a display 130. For example, the parallel processor 104 renders objects to produce values of pixels that are provided to the display 130, which uses the pixel values to display an image that represents the rendered objects. The parallel processor 104 includes a plurality of compute units (CU) 120 that execute instructions concurrently or in parallel. In some embodiments, each one of the CUs 120 includes one or more single instruction, multiple data (SIMD) units, and the CUs 120 are aggregated into workgroup processors, shader arrays, shader engines, or the like. The number of CUs 120 implemented in the parallel processor 104 is a matter of design choice and some embodiments of the parallel processor 104 include more or fewer compute units than shown in FIG. 1. In some embodiments, the CUs 120 are used to implement a graphics or texture pipeline. In some embodiments, the parallel processor 104 is used for general purpose computing.

The processing system 100 further includes a central processing unit (CPU) 102. The CPU 102, in at least some embodiments, includes one or more single-or multi-core CPUs. In various embodiments, the parallel processor 104 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

As illustrated in FIG. 1, the processing system 100 also includes a system memory referred to herein as global memory 106, an operating system 108, a communications infrastructure 110, and one or more applications 112. Access to the global memory 106 is managed by a memory controller (not shown) coupled to global memory 106. For example, requests from the CPU 102 or other devices for reading from or for writing to the global memory 106 are managed by the memory controller. In some embodiments, the one or more applications include various programs or commands to perform computations that are also executed at the CPU 102. The CPU 102 sends selected commands for processing at the parallel processor 104. The parallel processor 104 executes instructions such as program code of one or more applications 112 stored in the global memory 106 and the parallel processor 104 stores information in the global memory 106 such as the results of the executed instructions.

The operating system 108 and the communications infrastructure 110 are discussed in greater detail below. The processing system 100 further includes a driver 114 and a memory management unit, such as an input/output memory management unit (IOMMU) 116. Components of the processing system 100 are implemented as hardware, firmware, software, or any combination thereof. In some embodiments, the processing system 100 includes one or more software, hardware, and firmware components in addition to or different from those shown in FIG. 1.

Within the processing system 100, the global memory 106 includes non-persistent memory, such as DRAM (not shown). In various embodiments, the global memory 106 stores processing logic instructions, constant values, variable values during execution of portions of applications or other processing logic, or other desired information. For example, in various embodiments, parts of control logic to perform one or more operations on the CPU 102 reside within the global memory 106 during execution of the respective portions of the operation by the CPU 102. During execution, respective applications, operating system functions, processing logic commands, and system software reside in the global memory 106. Control logic commands that are fundamental to the operating system 108 generally reside in the global memory 106 during execution. In some embodiments, other software commands (e.g., a set of instructions or commands used to implement the device driver 114) also reside in the global memory 106 during execution by the processing system 100.

The IOMMU 116 is a multi-context memory management unit. As used herein, context is considered the environment within which kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 116 includes logic to perform virtual to physical address translation for memory page access for devices, such as the parallel processor 104. In some embodiments, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in the global memory 106.

In various embodiments, the communications infrastructure 110 interconnects the components of the processing system 100. The communications infrastructure 110 includes (not shown) one or more of a peripheral component interconnect (PCI) bus, extended PCI (PCI-e) bus, advanced microcontroller bus architecture (AMBA) bus, advanced graphics port (AGP), or other such communication infrastructure and interconnects. In some embodiments, the communications infrastructure 110 also includes an Ethernet network or any other suitable physical communications infrastructure that satisfies an application's data transfer rate requirements. The communications infrastructure 110 also includes the functionality to interconnect components, including components of the processing system 100.

A driver 114 communicates with a device (e.g., parallel processor 104) through an interconnect or the communications infrastructure 110. When a calling program invokes a routine in the driver 114, the driver 114 issues commands to the device. Once the device sends data back to the driver 114, the driver 114 invokes routines in an original calling program. In general, drivers are hardware-dependent and operating-system-specific to provide interrupt handling required for any necessary asynchronous time-dependent hardware interface. In some embodiments, a compiler 118 is embedded within the driver 114. The compiler 118 compiles source code into program instructions as needed for execution by the processing system 100. During such compilation, the compiler 118 applies transforms to program instructions at various phases of compilation. In other embodiments, the compiler 118 is a standalone application. In various embodiments, the driver 114 controls operation of the parallel processor 104 by, for example, providing an application programming interface (API) to software (e.g., applications) executing at the CPU 102 to access various functionality of the parallel processor 104.

In some embodiments, the processing system 100 includes input/output (I/O) engine 132 that includes circuitry to handle input or output operations associated with display 130, as well as other elements of the processing system 100 such as keyboards, mice, printers, external disks, and the like. The I/O engine 132 is coupled to the communications infrastructure 110 so that the I/O engine 132 communicates with the global memory 106, the parallel processor 104, and the CPU 102. In some embodiments, the CPU 102 issues one or more draw calls or other commands to the parallel processor 104. In response to the commands, the parallel processor 104 schedules, via the scheduler 124, one or more operations at the parallel processor 104. Based on the operations, the parallel processor 104 generates a rendered frame, and provides the rendered frame to the display 130 via the I/O engine 132.

The CPU 102 includes (not shown) one or more of a control processor, field-programmable gate array (FPGA), application-specific integrated circuit (ASIC), or digital signal processor (DSP). The CPU 102 executes at least a portion of the control logic that controls the operation of the processing system 100. For example, in various embodiments, the CPU 102 executes the operating system 108, the one or more applications 112, and the driver 114. In some embodiments, the CPU 102 initiates and controls the execution of the one or more applications 112 by distributing the processing associated with one or more applications across the CPU 102 and other processing resources, such as the parallel processor 104.

The parallel processor 104 executes commands and programs for selected functions, such as graphics operations and other operations that are particularly suited for parallel processing. In general, the parallel processor 104 is frequently used for executing graphics pipeline operations, such as pixel operations, geometric computations, and rendering an image to a display. In some embodiments, the parallel processor 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the parallel processor 104.

The parallel processor 104 includes one or more compute units to perform computations in accordance with a single-instruction-multiple-thread (SIMT) paradigm or a single-instruction-multiple-data (SIMD) paradigm. The SIMD execution model is one in which multiple processing elements share a single program control flow unit and program counter and thus execute the same program but are able to execute that program with different data. The number of compute units 120 implemented in the parallel processor 104 is configurable. Each compute unit 120 includes one or more processing elements such as scalar and or vector floating-point units, arithmetic and logic units (ALUs), and the like. In various embodiments, the compute units 120 also include special-purpose processing units (not shown), such as inverse-square root units and sine/cosine units. The components of the parallel processor 104 are implemented as hardware, circuitry, firmware, software, or any combination thereof.

Each of the one or more compute units 120 executes a respective instantiation of a particular work item to process incoming data, where the basic unit of execution in the one or more compute units 120 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a compute unit 120.

The parallel processor 104 issues and executes work-items, such as groups of threads executed simultaneously as a “wave”, on a single SIMD unit 122. Waves, in at least some embodiments, are interchangeably referred to as wavefronts, warps, vectors, or threads. In some embodiments, waves include instances of parallel execution of a shader program, where each wave includes multiple work items that execute simultaneously on a single SIMD unit 122 in line with the SIMD paradigm (e.g., one instruction control unit executing the same stream of instructions with multiple data). A scheduler 124 is configured to perform operations related to scheduling various waves on different CUs 120 and SIMD units 122 and performing other operations to orchestrate various tasks on the parallel processor 104.

The parallelism afforded by the one or more CUs 120 is suitable for graphics-related operations such as general-purpose compute and tensor operations, pixel value calculations, vertex transformations, tessellation, geometry shading operations, ray tracing, path tracing, and other graphics operations. In some implementations, the scheduler 124 issues work to the compute units 120 to perform general purpose compute operations, including operations to accelerate the calculation of tensor operations. Some parallel computation operations require that the same command stream or compute kernel be performed on streams or collections of input data elements. Respective instantiations of the same compute kernel are executed concurrently on multiple SIMD units 122 in the one or more compute units 120 to process such data elements in parallel. As referred to herein, for example, a compute kernel is a function containing instructions declared in a program and executed on parallel processor compute unit 120.

Each compute unit 120, in at least some implementations, further includes other components, such as an L1 cache 136, one or more register files 126, and scratchpad memory (not shown). The L1 cache 136 is a memory that stores frequently accessed data and instructions, which reduces latency by enabling rapid data retrieval. This cache typically holds data that is spatially and temporally local to the current computations, such as texture data, frequently used variables, and loop counters, minimizing the time spent on memory fetches and thus improving overall performance.

The register files 126, in at least some implementations, are a high-speed storage area, including registers used for holding data and intermediate results during computation. The register files 126 provide quick access to variables and temporary storage needed for executing instructions. In at least some implementations, each thread in the SIMD unit 122 has its own set of registers within the register files 126, which maintain the state of the SIMD unit 122 and perform independent calculations. The size and organization of the register files 126 support the high degree of parallelism and rapid context switching of the SIMD architecture. The scratchpad memory, in at least some implementations, is a programmable on-chip memory used for temporary storage of data to be accessed and manipulated by the threads within the compute unit 120. This memory facilitates efficient data sharing and communication between threads, enabling collaborative computation and reducing the necessity to access slower off-chip memory.

The parallel processor 104 includes other components, such as an L2 cache referred to as shared memory 145. The shared memory 145, in at least some implementations, acts as a shared resource for all compute units 120 by storing data and instructions that may be needed by multiple units, thereby reducing the need to access the slower global memory 106 frequently. By maintaining a hierarchical cache structure, the parallel processor 104 balances speed and capacity, which ensures efficient data retrieval across varying levels of memory access. The global memory 106 is used to store a majority of the data and instructions operated on by the parallel processor 104, including textures, frame buffers, shaders, and computational data sets.

One type of operation performed by the parallel processor 104 is the execution of Generalized Matrix Multiplication (GEMM) kernels 134. GEMMs kernels 134 are beneficial for various high-impact applications, such as machine learning, high-performance computing, scientific simulations, and the like. These operations typically involve multiplying matrices, which is computationally intensive and benefits from parallel processing. GEMM kernels 134 typically perform operations of the form C=α(A×B)+βD, where A is a matrix of size M×K with M being the number of rows and K being the inner dimension, B is a matrix of size K×N, D is a matrix of size M×N, C is the result matrix of size M×N and α and β are scaling factors. For the sake of simplification, it is assumed that α=1 and β=0, reducing the GEMM equation to C=A×B. This operation is well-suited for execution on highly parallel processors, such as GPUs.

The execution process of a GEMM kernel 134 includes multiple operations or processes, such as kernel preparation, data transfer, kernel invocation, execution on parallel processor components, matrix multiplication execution, result collection, and post-processing. In at least some implementations, the kernel preparation process includes compiling GEMM kernels 134 written in high-level languages into machine code and allocating parallel processor shared memory 145 for Matrix A, Matrix B, and Matrix C, and any temporary buffers. The data transfer process includes copying the input matrices from global memory 106 to the shared memory 145 and utilizing parallel processor computing frameworks for efficient memory transfers and synchronization.

The kernel invocation process includes defining the grid and block dimensions for the kernel launch, which determines how the computation is divided among the compute units 120 of the parallel processor 104 and work items, and using an API call to launch the GEMM kernel 134 on the parallel processor 104. Execution on the components of the parallel processor 104 involves the compute units 120 of the parallel processor 104, where the kernel execution is distributed across multiple compute units 120 and their SIMT or SIMD units 122. For example, work items are grouped into wavefronts, which execute in lockstep on SIMD units 122 to perform parallel execution of instructions on multiple data elements. The matrix multiplication execution process includes dividing the resulting matrix C into smaller tiles to improve data reuse and arithmetic intensity, with each tile mapped to a workgroup. Work items within a workgroup load elements of Matrix A and Matrix B from the global memory 106 into local registers or shared memory, perform multiply-accumulate operations, and synchronize within workgroups to manage data dependencies and avoid race conditions.

The result collection process includes writing the partial results computed by each workgroup back to the global memory 106. Once all partial results are computed, the resulting Matrix C is transferred from the shared memory 145 or directly from the register files 126 back to the global memory 106 (host memory). The post-processing process includes verifying the correctness of the output Matrix C and freeing the allocated shared memory 145, along with handling any necessary cleanup operations.

As indicated above, tiling is typically implemented to efficiently execute GEMM kernels 134. With the tiling process, each thread block loads a tile from Matrix A and Matrix B to calculate the partial product of a corresponding tile of Matrix C. Tiling helps to increase computational intensity by reusing data loaded from the parallel processor's memory, which has limited bandwidth and higher latency. This technique is particularly effective for larger matrices. However, for many matrix sizes, especially small or narrow matrices, tiling alone may not be sufficient to address the issue of being latency-bound. In these cases, conventional GEMM execution techniques remain latency-bound because there is not enough computational demand to effectively hide the latency of required memory accesses, even on highly parallel machines such as parallel processors.

To facilitate transfers of data between the shared memory 145 and the global memory 106, a compute unit (CU) 120 tasks a DMA controller 128 associated with the CU 120 with issuing instructions to copy data from the shared memory 145 to the global memory 106 (i.e., store instructions) and from the global memory 106 to the shared memory 145 (i.e., load instructions). In some implementations, each CU 120 includes four SIMD units 122, and each pair of SIMD units 122 connects to a DMA controller 128, such that each DMA controller 128 performs tensor load/store operations on behalf of its associated pair of SIMD units 122. The DMA controller 128 performs the copy operations asynchronously from the CU 120, such that the CU 120 is free to perform other tasks while awaiting satisfaction of the copy operations.

In some implementations, the CU 120 tasks the DMA controller 128 with copy operations by providing a descriptor (not shown) that contains information regarding the data (e.g., tensor) to be copied. For example, the descriptor includes tensor dimensions, tile dimensions, strides, padding, the global memory address to or from which the tensor is to be copied, and the shared memory address to or from which the tensor is to be copied. The DMA controller 128 “unrolls” the descriptor by generating the memory copy requests indicated by the descriptor. The descriptor is accompanied by metadata in some implementations. In some implementations, the CU 120 also provides the DMA controller 128 with instruction set architecture (ISA) fields specifying, e.g., the scope of memory operations.

To facilitate more efficient transfers of data written out from the register files 126 to the global memory 106 following a matrix multiplication operation, the DMA controller 128 is instructed to iteratively load portions of tensor data (i.e., subregions of tiles) from the global memory to the shared memory 145. Fetching non-contiguous subregions of data in an iterative fashion allows the CUs 120 to generate an output from matrix multiplication in a format in which rows of data fill full cachelines that are contiguous in memory. When each cacheline of result data from matrix C output to the register includes a row of contiguous data, the DMA controller 128 can store the results from the register (or the shared memory 145) to the global memory 106 in full cacheline-size chunks (i.e., transferring a full cacheline in each transfer operation), resulting in more efficient transfers of result data from the register files 126 to the global memory 106 than conventional transfers which must be performed in half-cacheline increments.

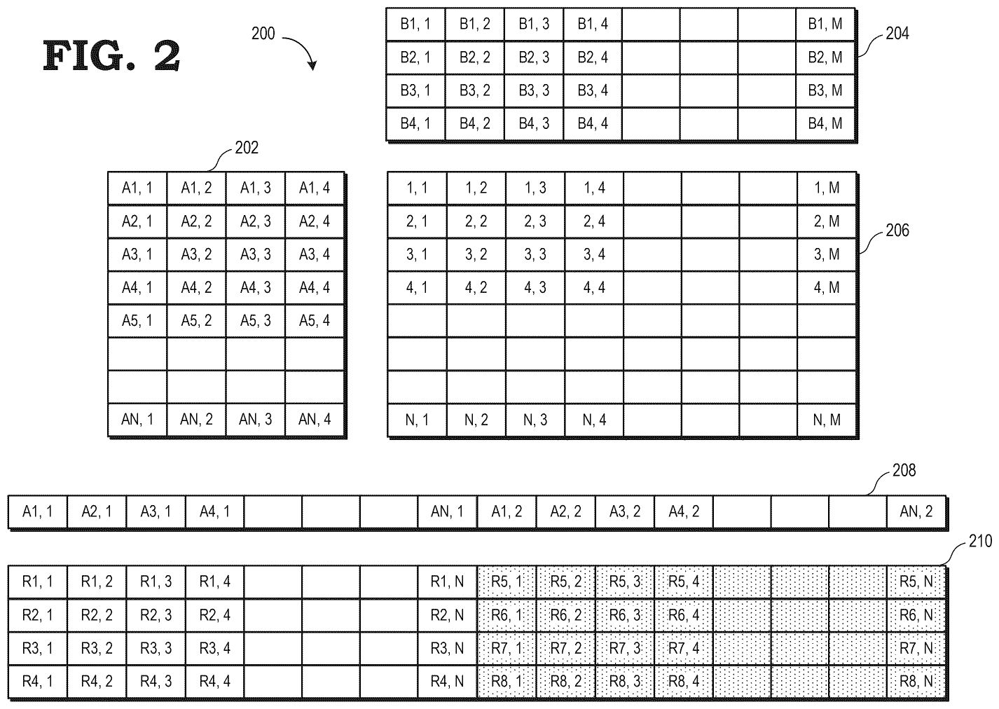

FIG. 2 is a diagram 200 illustrating normal operation of a DMA controller tasked with loading data to a local memory of a processor for matrix multiplication. FIG. 2 illustrates a high-level overview of General Matrix Multiply (GEMM) operations employed to calculate an output matrix C 206 based on two input matrices, input matrix A 202 and input matrix B 204. Matrix A 202 presents dimensions of K (horizontal) by M units (vertical); matrix B 204 displays dimensions of N (horizontal) and K (vertical).

Computation of a representative output tile from the C matrix 206 is performed by utilizing an input tile (not shown) from matrix A 202 and an input tile (not shown) from matrix B 204. The computation of an output tile (not shown) is performed by iteratively loading tiles from input matrices 202 and 204. For each iteration, the DMA controller only loads individual input tiles from the input matrices, negating the need for the entire submatrix. In some cases, the input tiles for matrix A 202 are loaded in row-major format into the shared memory 145, from which the data is pulled into a wavefront of, e.g., 64 threads with a fixed-function local data share transpose, thus providing the data in column-major format at an input register 208 for consumption by the CU 120. Thus, the first element stored at the input register 208 is element A[1, 1], the second element is element A[2, 1], the third element is A[3, 1], and so on until element A[N, 1]. Once all of the elements of the first column of Matrix A 202 (or a tile of Matrix A) have been loaded to the register 208, elements from the second column of Matrix A 202 (or a tile of Matrix A) are loaded (e.g., A[1, 2], A[2, 2], A[3, 2], . . . , A[N, 2]). In some cases, the input tiles for matrix A 202 are loaded in column-major format into the shared memory 145, from which the data is pulled into a wavefront of, e.g., 64 threads with a fixed-function local data share transpose, thus providing the data in row-major format at the input register 208 for consumption by the CU 120.

The DMA controller similarly loads Matrix B 204 into the shared memory 145 in row-major format in some cases, and the data from Matrix B 204 is pulled from the shared memory 145 into a wavefront of, e.g., 64 threads in row-major format. In other cases, the DMA controller loads Matrix B 204 into the shared memory 145 in column-major format, and the data from Matrix B 204 is pulled from the shared memory 145 into a wavefront in column-major format. Thus, in various cases, the layout in the shared memory 145 of [Matrix A 202, Matrix B 204] can take any of the following combinations: [row-major, column-major], [column-major, column-major], [row-major, row-major], and [column-major, row-major]. At each iteration, only individual tiles from input matrices 202, 204 are utilized, while each output tile of the output matrix 206 is stored within registers 210 in row-major format until fully computed —that is, product tiles of output matrix 206 are loaded only once, while input tiles of input matrices 202, 204 are loaded from memory repeatedly.

As shown in FIG. 2, loading the input register 208 in a linear column-major format results in the output tiles of the output matrix 206 that include blocks of data destined for non-sequential memory addresses. For example, the first row of the output matrix 206 includes result elements R[1, 1], R[1, 2], R[1, 3], . . . , R[1, N], R[5, 1], R[5, 2], R[5, 3], . . . , R[5, N]. Because result elements R [1, 1-N] and R [5, 1-N] are strided in global memory 106, they effectively reside in different cachelines. Storing each row of the output matrix 206 therefore cannot be accomplished in a single memory operation by the DMA controller 128, but instead requires multiple fetches by the DMA controller 128, resulting in poor cache performance when writing out the data.

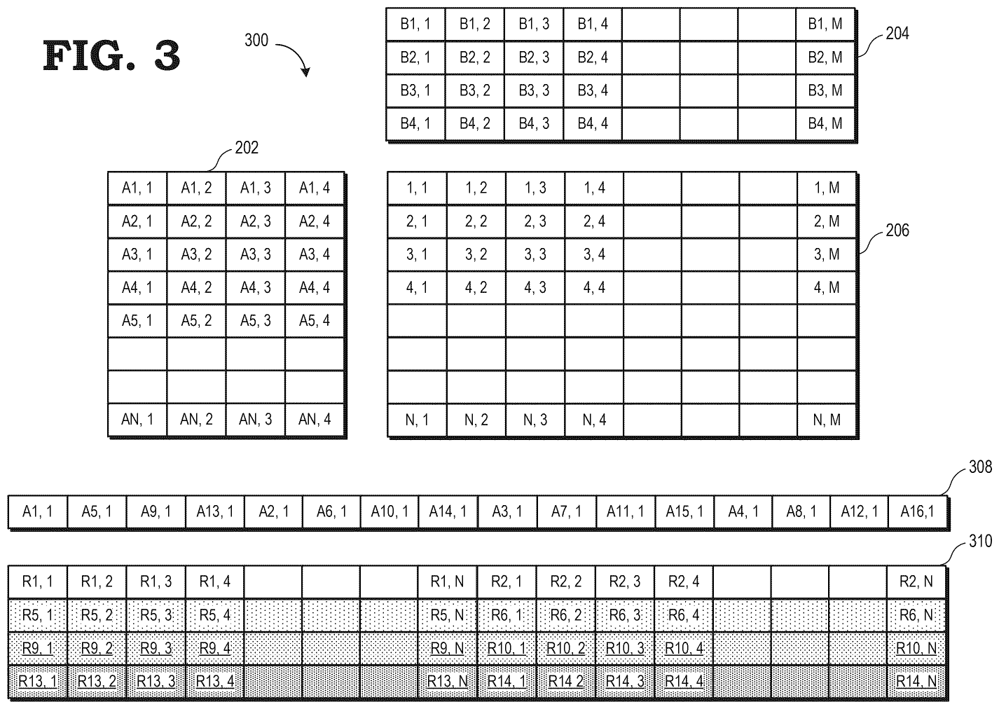

FIG. 3 is a diagram 300 illustrating iterative loading of data by the DMA controller 128 for cache-friendly write out following matrix multiplication using the data in accordance with some embodiments. Similar to FIG. 2, FIG. 3 illustrates a high-level overview of General Matrix Multiply (GEMM) operations employed to calculate the output matrix C 206 based on input matrices 202 and 204.

The input tiles for matrix A 202 are loaded in column-major format into an input register 208 for consumption by the CU 120. However, in contrast to the linear column-major format illustrated at input register 208 in FIG. 2, in the illustrated implementation, the DMA controller 128 iterates over a tile of Matrix A 202 when loading the tile into the shared memory 145. For example, in a first iteration, the DMA controller 128 loads a first portion of data from a tile of Matrix A 202 to the shared memory 145. The first portion of data is defined by a stride (e.g., 16 elements) and a number of elements per stride (e.g., 4 elements). In a second iteration immediately following the first iteration, the DMA controller 128 loads to the shared memory 145 a second portion of data from the tile of Matrix A 202 that is offset by a configurable amount from the first portion of data. The resulting layout in the input register 308 interleaves elements of the tile of Matrix A 202 in column major format by configurable amount of offset. Thus, for the offset of four elements illustrated in FIG. 3, the first element stored at the input register 308 is element A[1, 1], the second element is element A[5, 1], the third element is A[9, 1], and the fourth element is A[13, 1]. The pattern then repeats with elements A[2, 1], A[10, 1], A[14, 1], then A[3, 1], A[7, 1], A[11, 1], A[15, 1], and finally A[4, 1], A[8, 1], A[12, 1], A[16, 1]. In some implementations, although not shown in FIG. 3, once all of the elements of the first column of the first portion of Matrix A 202 have been loaded to the register 308, the row continues in the same fashion with the next column of the first portion of Matrix A 202 (e.g., with A[1, 2], A[5, 2], A[9, 2], A[13, 2], etc.) and so on until the cacheline is filled.

As shown in FIG. 3, iteratively loading the input register 308 in an interleaved column-major format results in the output tiles of the output matrix 306 including contiguous result elements in a single cacheline. For example, the first row of the output matrix 206 includes result elements R[1, 1], R[1, 2], R[1, 3], . . . , R[1, N], R[2, 1], R[2, 2], R[2, 3], . . . , R[2, N], etc. at the output register 310. Because result elements R [1, 1-N] and R [2, 1-N], etc. are contiguous in global memory 106, they reside in the same cacheline and can be written out to the global memory 106 in a single memory operation by the DMA controller 128, resulting in improved cache performance compared to the data layout illustrated in registers 210 of FIG. 2.

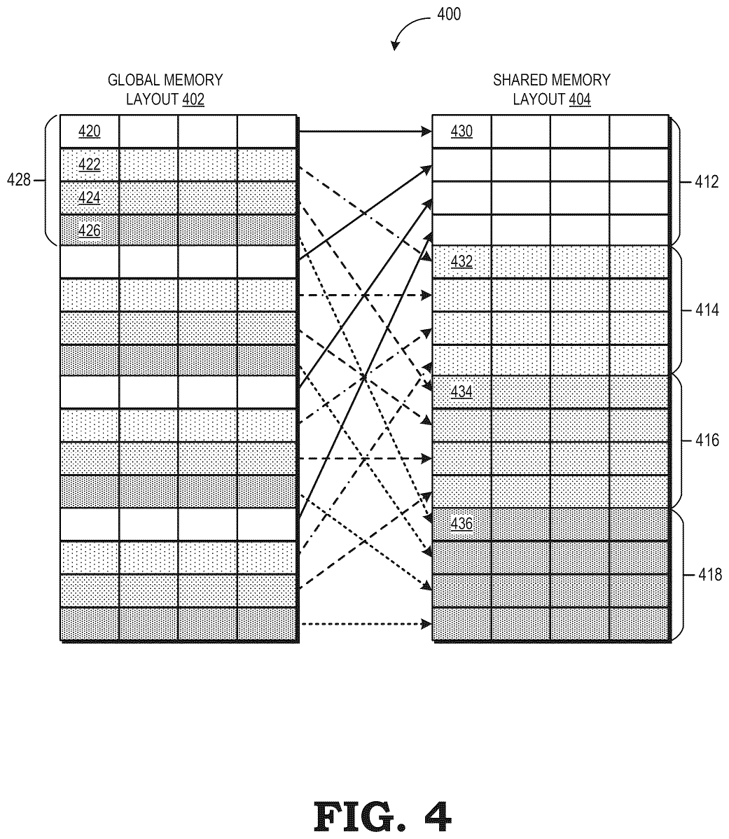

FIG. 4 is a diagram 400 illustrating iterative loading by the DMA controller 128 from the global memory 106 to the shared memory 145 in accordance with some embodiments. In response to a load instruction and a descriptor (not shown) indicating that the DMA controller 128 is to operate in an iterative loading mode, the DMA controller 128 loads data from a first portion of a tile of a tensor from the global memory 106 to the shared memory 145. Whereas the first portion of data has a global memory layout 402, due to the iterative fetching of the data by the DMA controller 128, the first portion of data is arranged in the shared memory 145 to have a shared memory layout 404.

In the illustrated example, the descriptor specifies iterations having a tensor tile stride 428 of four, such that the DMA controller 128 fetches every fourth row of data from the global memory 106 to the shared memory 145 at each iteration. Accordingly, in a first iteration 412, the DMA controller 128 fetches a first row of data starting with a global base address 420, a 5th row of data, a 9th row of data, and a 13th row of data, and places the elements of the first iteration at the shared memory 145 starting at a local base address 430. A second iteration 414 is offset from the first iteration by a configurable offset. In the illustrated example, the configurable offset is set to one, such that in the second iteration, the DMA controller 128 fetches the second row of data, the 6^{th} row, the 10^{th} row, and the 14^{th} row of data from the global memory 106 starting with an address 422 that is the global base address 420 plus the offset specified in the descriptor. The DMA controller 128 fetches the data of the second iteration to an address 432 in the shared memory 145 that is the local base address 430 plus the configurable offset.

A third iteration 416 is offset from the first iteration by 2× the configurable offset. Thus, in the third iteration, the DMA controller 128 fetches the third row of data, the 7^{th} row, the 11^{th} row, and the 15^{th} row of data from the global memory 106 starting with an address 424 that is the global base address 420 plus 2× the offset specified in the descriptor. The DMA controller 128 fetches the data of the third iteration to an address 434 in the shared memory 145 that is the local base address 430 plus 2× the configurable offset.

Similarly, a fourth iteration 418 is offset from the first iteration by 3× the configurable offset. Thus, in the third iteration, the DMA controller 128 fetches the 4^{th}, 8^{th}, 12^{th}, and 16^{th} rows of data from the global memory 106, starting with an address 426 that is the global base address 420 plus 3× the offset specified in the descriptor. The DMA controller 128 fetches the data of the fourth iteration to an address 436 in the shared memory 145 that is the local base address 430 plus 3× the configurable offset.

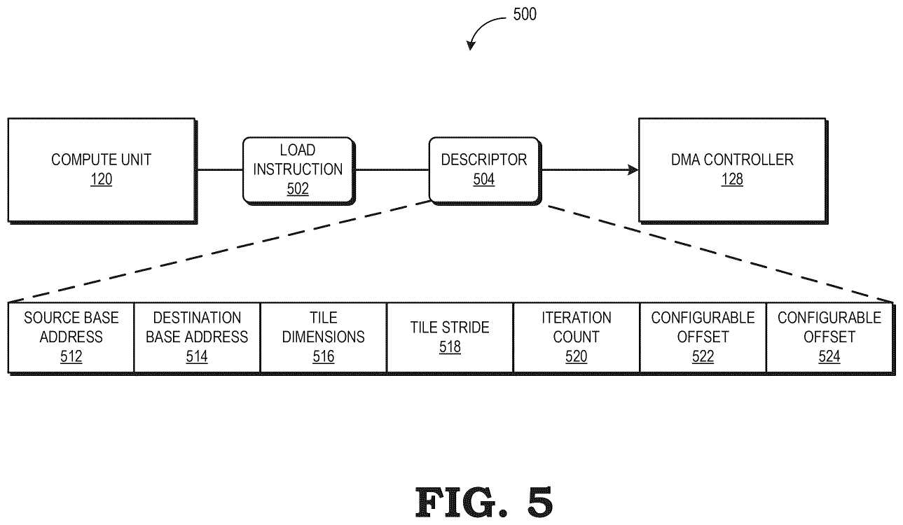

FIG. 5 is a diagram illustrating a compute unit 120 sending a load instruction 502 and a descriptor 504 including parameters for iterative direct memory access to a DMA controller 128 in accordance with some embodiments. In some implementations, the load instruction 502 includes an indication that the DMA controller 128 is to operate in an iterative mode. The descriptor 504 accompanying the load instruction 502 includes fields to indicate a source base address 512 for the iterative load instruction, a destination base address 514, tile dimensions 516 of each portion of data from the tile of tensor data to be loaded at each iteration, a tile stride 518, an iteration count 520, a configurable offset 522 for global memory, and a configurable offset 524 for shared memory.

The source base address 512 indicates the base address from which the data is to be loaded. Thus, for a load instruction 502 to load data from global memory 106 to shared memory 145, the source base address 512 indicates the address in global memory 106 of the first portion of data. The destination base address 514 indicates the base address in the destination memory to which the first iteration of the first portion of data is to be loaded. Thus, for a load instruction 502 to load data from global memory 106 to shared memory 145, the destination base address 514 indicates the address in the shared memory 145 to which the first iteration of the first portion of data is to be loaded. The tile dimensions 516 indicate the amount of data in each portion that is to be loaded from the global memory 106 to the shared memory 145. Thus, in the example of FIG. 4, the tile dimensions 516 of each portion is four rows. The tile stride 518 is the number of elements to be fetched per iteration. Thus, in the example of FIG. 4, the tile stride 518 is sixteen and the number of elements per stride is four, as the DMA controller 128 is to load elements 1-4, 17-20, 33-36, and 49-52 from the global memory 106 in the first iteration. The iteration count 520 indicates the number of times the DMA controller 128 is to repeat the iterative load operation (in the example illustrated in FIG. 4, the iteration count 520 is four). Finally, the configurable offset 522 indicates the offset from the source base address 512 and the configurable offset 524 indicates the offset from the destination base address 514 that the DMA controller 128 is to apply when loading the second portion of data from the tile of tensor data. In the example of FIG. 4, the configurable offset 522 is set to four, such that the second iteration loads a second portion of data including elements 5-8, 21-24, 37-40, and 53-56. In some implementations, the configurable offset 522 and the configurable offset 524 are independently configurable.

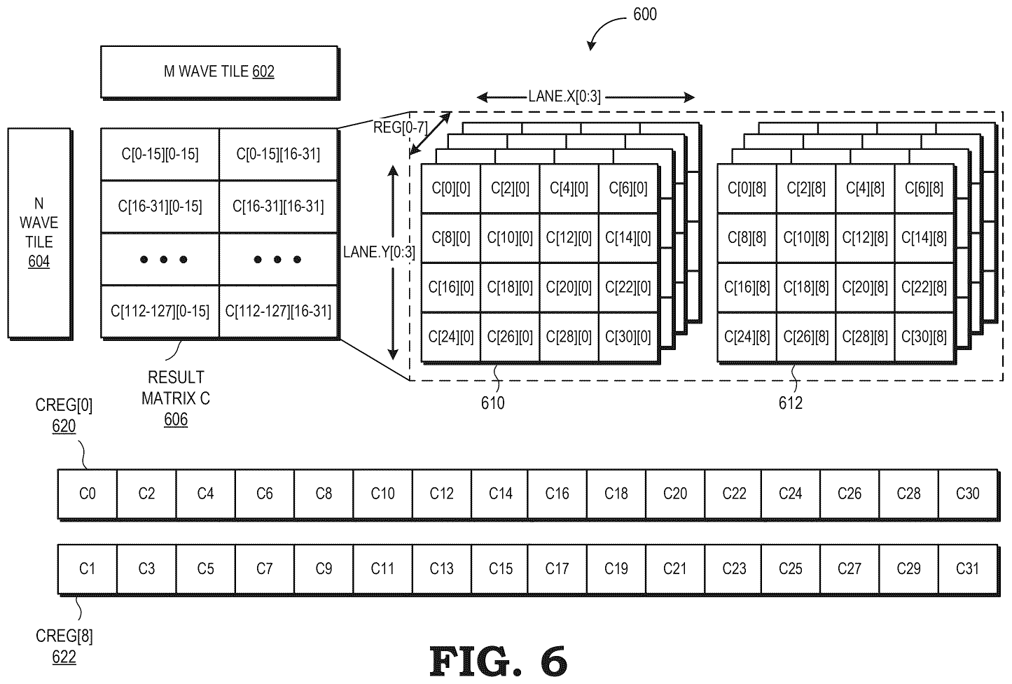

In some implementations, to further improve processing and write-out performance from the output registers of the compute units 120, the DMA controller 128 loads matrix data to the register files 126 with the matrix elements interleaved. FIG. 6 is a diagram illustrating interleaving of matrix elements at compute unit registers 620, 622 for processing of multiple elements in a single thread in accordance with some embodiments. To perform matrix multiplication, threads 610, 612 executing at a CU 120 calculate the product (result matrix C 606) of an N-wave tile 604 and an M-wave tile 602.

Conventionally, a DMA controller generates cacheline fetches of row elements linearly, such that the result matrix from a matrix multiplication operation on matrix tiles is also laid our linearly (e.g., C[0][0], C[1][0], C[2][0], C[3][0], etc.). In the result accumulator register, each cell is a thread holding the output of a row x column element in which each row is contiguous in memory and the columns are strided in memory. This layout can lead to bank conflicts when writing out the results from the output registers to the shared memory 145 or the global memory 106 unless additional instructions are used or padding is inserted to support the result register layout in the shared memory 145.

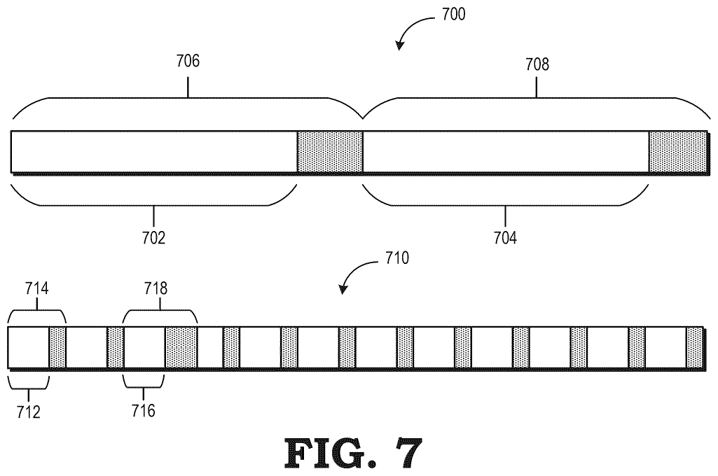

To facilitate writing out multiple elements per thread without encountering bank conflicts, the DMA controller 128 interleaves the elements of the N-wave tile 604 and the M-wave tile 602 to produce interleaved elements for the threads 610, 612: C[0][0], C[2], C[4][0], C[6][0], etc. The CU 120 accumulator registers 620, 622 can then split the output (e.g., 32 threads) into a 16×2 (row x column) output. Thus, as shown in the illustrated example, the register CReg[0] 620 includes even elements C0, C2, C4, C6, C8, . . . , C30, and the register CReg[8] 622 includes odd elements C1, C3, C5, C7, C9, . . . ,C31. In other implementations, the DMA controller 128 applies an interleaving stride of, e.g., 4 or 8, to pack a corresponding number of elements into the output from each thread Whereas parallel processor hardware supports padding interval values corresponding to powers of two, operating the DMA controller 128 in the iterative mode enables insertion of padding at flexible intervals with a limited number of DMA instructions. Some precision data types (e.g., f6 precision) do not necessarily align with byte or cacheline boundaries, leading to complications with computations and load/store operations that typically operate on integer multiples of bytes. For example, if a task includes 64 elements of f6 precision, the task includes 48 bytes, which is less than the size of a cacheline. FIG. 7 is a diagram illustrating insertion of padding at varying increments during iterative loading of data by the DMA controller 128 in accordance with some embodiments.

In a first example 700, tensor data is stored in increments 702, 704 at the global memory 106. A load instruction and descriptor instruct the DMA controller 128 to load the first increment of data 702 from an address range in global memory 106 spanning the first increment of data 702 to an address range in the shared memory 145 that spans the first address range plus a padding increment 706 specified by a padding field in the descriptor. In a second iteration, the DMA controller 128 loads a second increment of data 704 spanning a second address range from the global memory 106 to an address range in the shared memory 145 that spans the second address range plus a padding increment 708.

In a second example 710, a load instruction and descriptor instruct the DMA controller 128 to insert padding at each iteration on a smaller granularity. In the illustrated example, the cacheline includes 12 increments of data and padding. The DMA controller 128 loads a first increment of data 712 from an address range at the global memory 106 to a corresponding address range plus a first padding increment 714 in the shared memory 145. The DMA controller 128 repeats the load operation for a total of 12 iterations, thereby interspersing padding between increments of data. Using the iterative loading techniques described herein, the DMA controller 128 can insert padding of different sizes within a single operation. For example, as illustrated in FIG. 7, the DMA controller 128 loads a third increment of data 716 from an address range at the global memory 106 to a corresponding address range plus a second padding increment 718 in the shared memory 145.

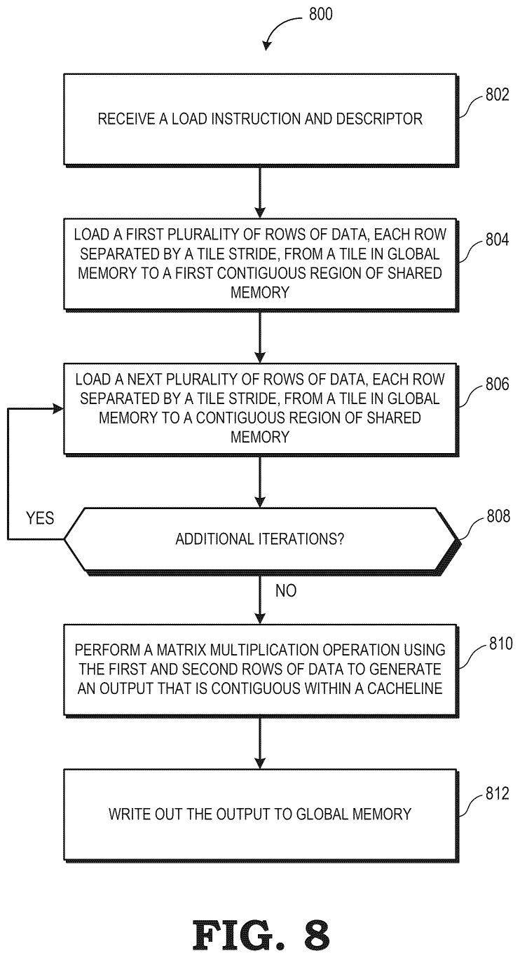

FIG. 8 is a flow diagram illustrating a method 800 for iteratively loading tensor tile data by a DMA controller in accordance with some embodiments. In some implementations, the method 800 is performed at a processing system such as processing system 100.

The method begins at block 802, at which the DMA controller 128 receives a load instruction and descriptor such as load instruction 502 and descriptor 504. The descriptor 504 indicates that the DMA controller 128 is to operate in an iterative mode and specifies a source base address 512, such as a base address in the global memory 106 from which the DMA controller 128 is to load data and a destination base address 514, such as a base address in the shared memory 145 to which the DMA controller 128 is to load the data. The descriptor 504 further specifies the tile dimensions 516 and a tile stride 518 that specifies the stride between rows of each portion of data. The descriptor 504 also specifies an iteration count 520 that is the number of iterations of loading data that the DMA controller 128 is to perform and which corresponds to the number of portions of data to be iteratively loaded from the tile. The descriptor 504 further specifies a configurable offset 522 between the source base address of the first portion of data and the second portion of data. In some implementations, the descriptor 504 also specifies an amount of padding to be inserted after each portion of data at the destination.

At block 804, the DMA controller 128 loads a first portion of data that includes a first plurality of rows of data from the source memory (e.g., the global memory 106). The first row of the first plurality of rows begins at the source base address 512. The rows of data are separated from each other by the tile stride 518 specified by the descriptor 504. The DMA controller 128 loads the strided data of the first portion from the global memory 106 to a contiguous (i.e., non-strided) region of the shared memory 145.

At block 806, the DMA controller 128 loads a second portion of data that includes a second plurality of rows of data from the global memory 106. The first row of the second plurality of rows begins at the source base address 512 plus the configurable offset 522. The rows of data are separated from each other by the tile stride 518 specified by the descriptor 504. The DMA controller 128 loads the strided data of the second portion from the global memory 106 to a contiguous (i.e., non-strided) region of the shared memory 145 that is also contiguous with the first portion of data.

At block 808, the DMA controller 128 determines whether additional iterations are specified by iteration count 520 of the descriptor 504. If the are additional iterations in the iteration count 520 (i.e., if the iteration count is greater than the number of completed iterations), the method flow continues to block 806 for the next load iteration. If the iteration count 520 has been completed, the method flow continues to block 810.

At block 810, the compute units 120 of the parallel processor 104 perform a matrix multiplication operation using the first and second portions of data to generate an output that is contiguous within a cacheline. In some implementations, the DMA controller 128 interleaves the elements of the tile to facilitate packing multiple elements in each thread.

At block 812, the DMA controller 128 writes out the output from the matrix multiplication operation to the global memory 106. Due to the layout of the data in the shared memory 145 from the iterative load operations and interleaving of elements, the results from the matrix multiplication operation are contiguous within each cacheline and can therefore be written out to the global memory in fewer iterations. The increased write out efficiency reduces latency, particularly for matrix multiplication operations involving matrices with relatively small k dimensions.

In some embodiments, the apparatus and techniques described above are implemented in a system including one or more integrated circuit (IC) devices (also referred to as integrated circuit packages or microchips), such as the processing system described above with reference to FIGS. 1-8. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc.

This phrase is not used herein to refer to something intangible. Further, the term “configured to” is not intended to mean “configurable to. ” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
iteratively loading, at a direct memory access (DMA) controller, portions of data from a tile comprising a plurality of portions of data from a global memory to a shared memory of a processor for matrix multiplication, wherein iteratively loading comprises loading the portions of data from a first region in global memory to a second region in the shared memory, wherein rows of the first region offset by a tile stride are stored in contiguous rows of the second region.

2. The method of claim 1, wherein iteratively loading further comprises:
in a first iteration, loading a first portion of data comprising a plurality of rows from the tile, wherein each row is separated by a tile stride, to a first contiguous region of the shared memory; and
in a second iteration, loading a second portion of data comprising a plurality of rows from the tile, wherein each row is separated by the tile stride and wherein the second portion of data is offset from the first portion of data in global memory, to a second contiguous region of the shared memory.

3. The method of claim 1, wherein iteratively loading further comprises:
in a first iteration, loading a first portion of data comprising a plurality of rows from the tile, wherein each row is contiguous, to a first region of non-contiguous rows of the shared memory, wherein each non-contiguous row is separated by an offset; and
in a second iteration, loading a second portion of data comprising a plurality of rows from the tile, wherein each row is contiguous and wherein the second portion of data is separated by a tile stride from the first portion of data in global memory, to a second region of non-contiguous rows of the shared memory, wherein each non-contiguous row is contiguous with each first region of non-contiguous rows.

4. The method of claim 1, further comprising:
generating an output from the processor following a matrix multiplication operation using a first portion of data and a second portion of data in the shared memory, wherein the output comprises data that is contiguous within a cacheline for writing out to global memory.

5. The method of claim 1, wherein iteratively loading comprises iteratively loading a
first portion of data to a base destination address of the shared memory and
loading a second portion of data to the base destination address plus a configurable offset.

6. The method of claim 1, further comprising:
inserting padding to at least one of the portions of data at the shared memory.

7. The method of claim 1, wherein iteratively loading is in response to a load instruction and a descriptor indicating at least one of a size of the tile, the tile stride, a base address of the tile at the global memory, a destination address of the tile at the shared memory, a number of times to iterate loading, and an amount of padding to be added to one or more of the portions of data at the shared memory.

8. The method of claim 1, further comprising:
interleaving a first portion of data and a second portion of data at the shared memory.

9. The method of claim 8, further comprising:
at the processor, processing a number of elements of the tile in a single thread, the number of elements corresponding to a stride of the interleaving.

10. A processing system comprising:
a global memory;
a processor comprising a shared memory; and
a direct memory access (DMA) controller configured to:
iteratively load portions of data from a tile comprising a plurality of portions of data from the global memory to the shared memory for matrix multiplication, wherein to iteratively load comprises:
in a first iteration, load a first portion of data comprising a plurality of rows from the tile, wherein each row is separated by a tile stride, to a first contiguous region of the shared memory; and
in a second iteration, load a second portion of data comprising a plurality of rows from the tile, wherein each row is separated by the tile stride and wherein the second portion of data is offset from the first portion of data in global memory, to a second contiguous region of the shared memory.

11. The processing system of claim 10, wherein the DMA controller is further configured to:
generate an output from the processor following a matrix multiplication operation using the first portion of data and the second portion of data in the shared memory, wherein the output comprises data that is contiguous within a cacheline for writing out to the global memory.

12. The processing system of claim 10, wherein the DMA controller is further configured to:
load the first portion of data to a base destination address of the shared memory and load the second portion of data to the base destination address plus a configurable offset.

13. The processing system of claim 10, wherein the DMA controller is further configured to:
insert padding to at least one of the first portion of data and the second portion of data at the shared memory.

14. The processing system of claim 10, wherein the DMA controller is further configured to:
iteratively load the portions of data in response to a load instruction and a descriptor indicating at least one of a size of the tile, the tile stride, a base address of the tile at the global memory, a destination address of the tile at the shared memory, a number of times to iterate loading, and an amount of padding to be added to one or more of the portions of data at the shared memory.

15. The processing system of claim 10, wherein the DMA controller is further configured to:
in a third iteration, load a third portion of data comprising a plurality of rows from the tile, wherein each row is separated by the tile stride and wherein the third portion of data is offset from the second portion of data in global memory.

16. The processing system of claim 10, wherein the DMA controller is further configured to:
iteratively load successive portions of data from the tile until a configurable number of iterations have been performed.

17. The processing system of claim 10, wherein the DMA controller is further configured to:
interleave the first portion of data and the second portion of data at the shared memory.

18. The processing system of claim 17, wherein the processor is further configured to:
process a number of elements of the tile in a single thread, wherein the number of elements corresponds to a stride by which the first portion of data and the second portion of data are interleaved.

19. A parallel processor, comprising:
a processor to perform matrix multiplication;
a shared memory associated with the processor; and
a direct memory access (DMA) controller configured to iteratively load portions of data from a tile at first region in a global memory to a second region in the shared memory, wherein rows of the first region that are offset by a tile stride are stored in contiguous rows of the second region.

20. The parallel processor of claim 19, wherein the DMA controller is further configured to:
iteratively load the portions of data in response to receiving a load instruction and a descriptor indicating at least one of a size of the tile, the tile stride, a base address of the tile at the global memory, a destination address of the tile at the shared memory, a number of times to iterate loading, and an amount of padding to be added to one or more of the portions of data at the shared memory.
